(19) United States
(12) Patent Application Publication
(10) Pub. No.: US 2026/0182549 A1
(43) Pub. Date: Jul. 2, 2026

(54) EXPERIMENTAL METHOD FOR LOW-HIGH TEMPERATURE HATCHING STIMULATION AND DUAL-HIGH TEMPERATURE TOLERANCE THRESHOLD DETERMINATION FOR SCHIZOTHORACINE FISH EGGS IN HIGH DIURNAL TEMPERATURE VARIATION WATERS

(71) Applicant: Changjiang River Scientific Research Institute, Wuhan (CN)

(72) Inventors: Li Lin, Wuhan (CN); Wei Li, Wuhan (CN); Weijie Guo, Wuhan (CN); Weihua Zhao, Wuhan (CN); Han Liu, Wuhan (CN); Dandan Gong, Wuhan (CN); Yuting Zhang, Wuhan (CN)

(21) Appl. No.: 19/392,152

(22) Filed: Nov. 18, 2025

(30) Foreign Application Priority Data
Dec. 31, 2024 (CN) 2024119839498

(51) Int. Cl. A01K 61/17

(52) U.S. Cl. CPC A01K 61/17

(57) ABSTRACT

An experimental method for low-high temperature hatching stimulation and dual-high temperature tolerance threshold determination for schizothoracine fish eggs in high diurnal temperature variation waters includes: step 1, determining daily extreme water temperatures and a daily water temperature variation during natural incubation of the schizothoracine fish eggs; step 2, implementing an incubation water temperature with the daily water temperature variation; step 3, determining a key hatching water temperature; step 4, inducing mass hatching of the schizothoracine embryos; and step 5, determining temperature tolerance thresholds. Through indoor water temperature gradient experiments on the schizothoracine fish eggs, a hatching mechanism under low-high temperature stimulation for fertilized eggs of Schizopygopsis microcephalus in Yangtze River source, and dual-high temperature tolerance ranges and thresholds. This provides scientific support for the protection and restoration of fishery resources in the Yangtze River source under the background of global warming.

### CROSS-REFERENCE TO RELATED APPLICATION

This application claims priority to Chinese Patent Application No. 202411983949.8, filed on Dec. 31, 2024, which is herein incorporated by reference in its entirety.

### TECHNICAL FIELD

The disclosure relates to the field of fish ecological adaptation, and more particularly to an experimental method for low-high temperature hatching stimulation and dual-high temperature tolerance threshold determination for schizothoracine fish eggs in high diurnal temperature variation waters.

### BACKGROUND

Fish are typical ectothermic animals, unable to regulate their body temperature autonomously. Their body temperature is directly influenced by ambient water temperature and varies with changes in the ambient water temperature. Fertilized egg stage is a most vulnerable phase in a life cycle of fish, being highly sensitive to environmental changes, particularly to fluctuations in water temperature. Fertilized eggs serve as an excellent material for investigating response of the fish to changes in the water temperature.

Tibetan Plateau is a region sensitive to global climate change. Due to polar amplification effect, an atmospheric warming rate on the Tibetan Plateau is twice a global average temperature change rate. Climate warming affects thermal conditions of rivers, which in turn impacts environment and aquatic life. Schizothoracine fish are important species in river and lake ecosystems of the Tibetan Plateau. Existing research indicates that within a certain range, increased water temperature can accelerate hatching speed of fish eggs, and activity and efficiency of enzymes in fish are affected by temperature. However, adaptability of the fish eggs to water temperature changes is limited; excessively high or low water temperatures can lead to abnormal development, developmental stagnation, or even death of the fish eggs. There are also differences in sensitivity of eggs from different fish species to water temperature. Researching sensitivity of the schizothoracine fish eggs to water temperature and controlling the water temperature within an appropriate range can promote normal development and hatching of the schizothoracine fish eggs. Currently, there are few studies on hatching water temperature of the schizothoracine fish eggs, with only optimal hatching water temperatures for four fish species reported. Researcher Wang Hongyong's team uses a constant temperature system to design three different hatching water temperature experiments and finds that an optimal water temperature for artificial hatching of Schizothorax macrophogon is 8.5° C. to 9.5° C. Researcher Liu Yanchao's team designs five groups of constant temperature hatching experiments with average water temperatures of 5° C., 8° C., 11° C., 14° C., and 17° C., and finds that a suitable temperature for Schizopygopsis younghusbandi embryos is 14° C. to 17° C., and a suitable hatching water temperature for Oxygymnocypris stewartia embryos is 11° C. to 17° C. Researcher Zeng Benhe's team designs eight groups of constant temperature fertilized egg hatching experiments with water temperatures of 5° C., 9° C., 12° C., 14° C., 16° C., 18° C., 20° C., and 22° C., and finds that a minimum temperature for embryonic development of Schizothorax waltoni is 5° C., a maximum temperature threshold is 22° C., and a suitable water temperature is 12° C. to 16° C. A water temperature process experienced during a development period of the fish eggs affects a water temperature tolerance of fish at later life stages. It is obvious that under artificial conditions, hatching fish eggs that experience drastic daily water temperature changes in a natural environment requires designing a similar drastic change in the hatching water temperature process. Otherwise, it will affect the water temperature tolerance of artificially propagated fish and effect of stock enhancement and release. However, the above studies only consider a suitable hatching water temperature of schizothoracine fish embryos under constant temperature conditions and did not explore impact of drastic daily water temperature changes on embryonic development, nor do they conduct in-depth research on a low-high temperature stimulation process. During a breeding season of the schizothoracine fish, the natural water temperature of headwater rivers of the Tibetan Plateau shows a drastic daily change, with a daily amplitude of up to 16° C., which is significantly different from plain rivers. It is necessary to construct a water temperature demand mechanism for the development of the fish eggs in the natural drastic daily temperature difference water temperature region. Under the background of global climate warming and fish translocation protection research, it is urgent to construct a schizothoracine fish hatching water temperature system.

Schizopygopsis microcephalus is a fish species endemic to China. As a key species in the water ecosystem of headwaters of Yangtze River, it is crucial for maintaining fish diversity and aquatic ecosystem functions in the headwaters of the Yangze River. It holds exceptionally high scientific value and is a representative species among the schizothoracine fish. The headwaters of the Yangtze River experience drastic daily water temperature fluctuations, and a hatching water temperature system for fertilized eggs of Schizopygopsis microcephalus has not yet been established. Given an extremely high ecological value of Schizopygopsis microcephalus, it is of great significance to promote the protection of rare biological resources of the schizothoracine fish on the Tibetan Plateau against the backdrop of climate change and to break through a method of constructing the hatching water temperature system for the fertilized eggs of Schizopygopsis microcephalus in the headwaters of the Yangtze River.

### SUMMARY

To solve the above technical problems, a purpose of the disclosure is to provide an experimental method for exploring hatching and dual-high temperature tolerance thresholds of schizothoracine fish eggs in natural high diurnal temperature variation waters. A purpose of this method is to provide a water temperature system support for the schizothoracine fish eggs in artificial incubation regions and to offer a scientific basis for assessing the impact of water temperature rise on the development of the schizothoracine fish eggs in the artificial incubation regions under climate change. The disclosure also serves as a reference for the construction of artificial incubation water temperatures for other schizothoracine fish species.

To achieve the above purpose, the disclosure adopts the following technical solution.

An experimental method for low-high temperature hatching stimulation and dual-high temperature tolerance threshold determination for schizothoracine fish eggs (also referred to as fertilized eggs of schizothoracine fish) in high diurnal temperature variation waters includes the following steps:
step 1, determining daily extreme water temperatures and a daily water temperature variation during natural incubation of the schizothoracine fish eggs, including:
   installing an automatic underwater temperature recorder at a spawning site to record hourly water temperatures during an incubation period of the schizothoracine fish eggs, and analyzing, based on the hourly water temperatures, diurnal periodicity by using wavelet analysis to determine a daily maximum water temperature Tₘₐₓ and a daily minimum water temperature Tₘᵢₙ;
step 2, implementing an incubation water temperature with the daily water temperature variation, including:
   conducting an incubation process of the schizothoracine fish eggs by using an indoor basin-type artificial incubation method, with an incubation density of 40,000 eggs per square meter to 50,000 eggs per square meter and a depth of incubation water of 15 centimeters (cm) to 20 cm; using spring water with a temperature of 5° C. to 9° C. as the incubation water, and mixing the spring water with boiled spring water to achieve the incubation water temperature; maintaining an incubation room temperature at 13° C. to 14° C., corresponding to an average temperature during the natural incubation of the schizothoracine fish eggs, to shorten an incubation time of the schizothoracine fish eggs, and setting a lighting condition of the incubation process to 14L:10D, with no direct sunlight, where L represents daytime, and D represents nighttime; setting the incubation water temperature to (13° C., Tₘₐₓ); during the incubation process, increasing the incubation water temperature once daily to Tₘₐₓ, and then automatically decreasing the incubation water temperature to the incubation room temperature, to simulate diurnal temperature variation and promote embryonic development; and replacing, daily at 15:00 p.m., four-fifths of the incubation water with new spring water adjusted to a temperature of Tₘₐₓ, and promptly removing dead schizothoracine embryos to maintain freshness of the incubation water;
step 3, determining a key hatching water temperature, including:
   determining a time when a tail of each of schizothoracine embryos is fully developed as an optimal timing for hatching, wherein when the tail of each of schizothoracine embryos is fully developed, the tail of the schizothoracine embryo encircles and extends to a head of the schizothoracine embryo, a length of the tail of the schizothoracine embryo is half of an inner membrane circumference of the schizothoracine embryo, and the schizothoracine embryos exhibit a preset movement state comprising tumbling and rotation; setting a hatching water temperature initially to the daily minimum water temperature Tₘᵢₙ, and increasing the hatching water temperature gradually at a rate of 1° C. per 0.5-hour interval; and determining, based on whether the schizothoracine embryos hatch, the key hatching water temperature Tₕₐₜ;
step 4, inducing mass hatching of the schizothoracine embryos through low-high temperature stimulation, including:
   determining an arrival of a peak of a hatching period of the schizothoracine embryos, then stimulating the schizothoracine embryos with the incubation water of the daily minimum water temperature Tₘᵢₙ from 9:00 a.m. to 10:00 a.m., and subsequently stimulating the schizothoracine embryos with the incubation water of the daily maximum water Tₘₐₓ from 15: 00 p.m. to 17:00 p.m., to thereby achieve the low-high temperature stimulation; and conducting, after the low-high temperature stimulation, the mass hatching of the schizothoracine embryos within an effective period of 3 hours, where the low-high temperature stimulation promotes the hatching of the schizothoracine embryos; and
step 5, determining temperature tolerance thresholds, including:
   during the hatching period, performing, based on the daily minimum water temperature Tₘᵢₙ as a lower limit temperature, a high-temperature gradient experiment by gradually increasing the daily maximum water Tₘₐₓ by 1° C. to explore a high-temperature stage high-temperature tolerance threshold in a high-temperature stage, daily observing and recording a number of dead schizothoracine embryos and a number of hatched schizothoracine embryos, and determining, based on a 60% hatching rate limit, the high-temperature stage high-temperature tolerance threshold Tᵤₜₕᵣ (i.e., upper threshold temperature) in the high-temperature stage; and
   during the hatching period, performing, based on the daily maximum water temperature Tₘₐₓ as an upper limit temperature, a low-temperature gradient experiment by gradually increasing the daily minimum water temperature Tₘᵢₙ by 1° C. to explore a low-temperature stage high-temperature tolerance threshold in a low-temperature stage, and determining, based on the 60% hatching rate limit, the low-temperature stage high-temperature tolerance threshold Tₗₜₕᵣ (i.e., lower threshold temperature) in the low-temperature stage.

The disclosure may achieve the following beneficial effects.

By determining the daily extreme water temperatures and the daily water temperature variation during the natural incubation of the schizothoracine fish eggs, the disclosure designs incubation water temperatures with different daily water temperature variations, and simulates a natural hatching environment of Tibetan Plateau rivers with high diurnal temperature variation under climate change conditions. For the first time in fish ecological research, a concept of dual-high temperature thresholds is proposed. Through indoor water temperature gradient experiments on fertilized eggs, a mechanism of the mass hatching of Schizopygopsis microcephalus (a key fish species in the Yangtze River source) requires the low-high temperature stimulation is revealed. The key hatching water temperature is identified, and the hatching water temperature tolerance range and the dual-high temperature thresholds for the fertilized eggs of this key fish species are discovered. Ultimately, the adaptation mechanism of plateau cold-water schizothoracine fish to high diurnal temperature variation in water is revealed in general. This systematic method is applicable to the Tibetan Plateau region with high diurnal temperature variation in water and its fish research, and has great value for promotion. The disclosure has a wide range of applications, high scientific feasibility, and strong controllability. A high hatching rate and a low dead rate of the schizothoracine embryos prove that the practical application effect is good. The disclosure provides scientific support for the protection and restoration of fishery resources in the Yangtze River source under the background of future global warming.

### BRIEF DESCRIPTION OF DRAWINGS

FIG. 1 illustrates a schematic diagram of a water temperature variation process in a low-temperature 7° C. to high-temperature 22° C. experiment according to an embodiment 1 of the disclosure.

FIG. 2 illustrates a schematic diagram of a water temperature variation process in a low-temperature 9° C. to high-temperature 24° C. experiment according to an embodiment 2 of the disclosure.

FIG. 3 illustrates a schematic diagram of a water temperature variation process in a low-temperature 11° C. to high-temperature 26° C. experiment according to an embodiment 3 of the disclosure.

FIG. 4 illustrates a schematic diagram of daily percentage changes of dead eggs and hatched eggs in the low-temperature 7° C. to high-temperature 22° C. experiment according to the embodiment 1 of the disclosure.

FIG. 5 illustrates a schematic diagram of daily percentage changes of dead eggs and hatched eggs in the low-temperature 9° C. to high-temperature 24° C. experiment according to the embodiment 2 of the disclosure.

FIG. 6 illustrates a schematic diagram of daily percentage changes of dead eggs and hatched eggs in the low-temperature 11° C. to high-temperature 26° C. experiment according to the embodiment 3 of the disclosure.

### DETAILED DESCRIPTION OF EMBODIMENTS

To make purpose, technical solutions, and advantages of embodiments of the disclosure clearer, the following will provide a clear and complete description of the technical solutions in the embodiments of the disclosure in conjunction with attached drawings of the embodiments. It is apparent that described embodiments are only a part of the embodiments of the disclosure and not all of them. Any other embodiments obtained by those skilled in the art without making any inventive effort are within the scope of protection of the disclosure.

The embodiments of the disclosure aim to analyze water temperature characteristics of a natural incubation environment with high diurnal temperature variation in headwater rivers of Tibetan Plateau, and to construct an experimental method for low-high temperature hatching stimulation and dual-high temperature tolerance threshold determination through experimental ecology. The discovery of a hatching mechanism under low-high temperature stimulation and the introduction of a concept of dual-high temperature tolerance thresholds represent significant innovations in the field of fish thermal ecology. The following detailed description is provided through specific embodiments.

### Embodiment 1

Construction of incubation water temperature for schizothoracine fish eggs at low-temperature 7° C. to high-temperature 22° C.

### 1. Determination of Daily Extreme Water Temperatures and a Daily Water Temperature Variation During Natural Incubation of Schizothoracine Fish Eggs

Specifically, an automatic underwater temperature recorder is installed at spawning site of Schizopygopsis microcephalus (a species of the schizothoracine fish) to record hourly water temperatures during an incubation period of the fertilized eggs. Based on the hourly water temperatures, diurnal periodicity is analyzed by using wavelet analysis to determine that a daily maximum water temperature Tₘₐₓ is 22° C. and a daily minimum water temperature Tₘᵢₙ is 7° C.

### 2. Implementation of an Incubation Water Temperature With the Daily Water Temperature Variation

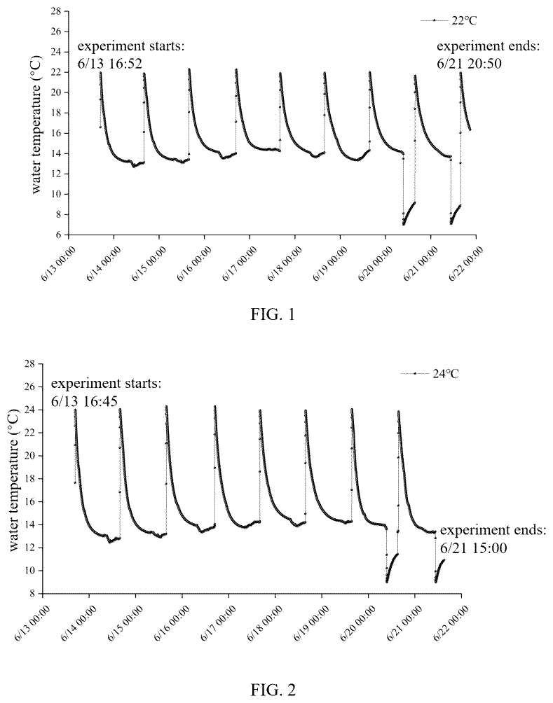

Specifically, an incubation process of the schizothoracine fish eggs is conducted by using an indoor basin-type artificial incubation method, with an incubation density of 40,000 eggs per square meter and a depth of incubation water of 15 cm. Spring water is used as the incubation water, which ensures excellent quality of the incubation water, while taking advantage of fewer bacteria and viruses in groundwater (i.e., the spring water) at high-altitude regions. A temperature of the spring water is 5° C., thus, the incubation water temperature is achieved by mixing the spring water with boiled spring water. An incubation room temperature is maintained at 13° C., and dissolved oxygen and ammonia nitrogen levels are appropriate during the incubation process. A light condition of the incubation process is set at 14L:10D, with no direct sunlight, where L represents daytime, and D represents nighttime. The incubation water temperature is set to (13° C., 22° C.) . A water temperature variation process during tan incubation experiment of 22° C. is shown in FIG. 1. The incubation experiment starts at 16:52 on June 13^{th} and ends at 20:50 on June 21^{st}. During the incubation process, the incubation water temperature is increased once daily to 22° C., and then the incubation water temperature is automatically decreased to the incubation room temperature, to simulate diurnal temperature variation and promote embryonic development with a higher water temperature. A total of eight cooling and heating cycles are conducted throughout the incubation experiment. Four-fifths of the incubation water are replaced daily at 15:00 p.m. with new spring water adjusted to 22° C., and dead schizothoracine embryos are promptly removed to maintain freshness of the incubation water.

### 3. Determination of a Key Hatching Water Temperature

Specifically, a time when a tail of each of schizothoracine embryos is fully developed is determined as an optimal timing for hatching. When the tail of each of schizothoracine embryos is fully developed, the tail of the schizothoracine embryo encircles and extends a head of the schizothoracine embryo, a length of the tail of the schizothoracine embryo is approximately half of an inner membrane circumference of the schizothoracine embryo, and the schizothoracine embryos exhibit a preset movement state including tumbling and rotation. A hatching temperature is initially set to the daily minimum water temperature 7° C., and the hatching water temperature is gradually increased at a rate of 1° C. per 0.5-hour interval. The key hatching water temperature Tₕₐₜ is determined based on whether the schizothoracine embryos hatch. No hatching is observed when the hatching water temperature is increased to 18° C.; however, a certain number of the schizothoracine embryos begins to hatch when the hatching water temperature is increased to 19° C., thus determining the key hatching water temperature as 19° C.

### 4. Induction of Mass Hatching of the Schizothoracine Embryos Through Low-High Temperature Stimulation

Specifically, an arrival of a peak (corresponding to the afternoon of June 19^{th} of FIG. 1) of a hatching period of the schizothoracine embryos is determined. Then, the schizothoracine embryos are first stimulated with the incubation water of the daily minimum water temperature Tₘᵢₙ (7° C.) from 9:00 a.m. to 10:00 a.m., followed by stimulation with the incubation water of the daily maximum water temperature Tₘₐₓ (22° C.) from 15:00 p.m. to 17:00 p.m., to thereby achieve the low-high temperature stimulation. As shown in FIG. 4, it illustrates daily percentage changes of hatched schizothoracine embryos and dead schizothoracine embryos (i.e., daily percentage changes of hatched eggs and dead eggs) for the incubation experiment of 22° C. After the low-high temperature stimulation, the mass hatching of the schizothoracine embryos occurs with an effective period of 3 hours. The daily percentage of the hatched schizothoracine embryos reaches a maximum value on the evening of June 20^{th}, confirming the induction of the mass hatching. Thus, the low-high temperature stimulation actively promotes and facilitates the hatching of the schizothoracine embryos.

### 5. Determination of Dual-High Temperature Tolerance Thresholds

Specifically, during the hatching period, based on 7° C. as a lower limit temperature, a high-temperature gradient experiment is performed by gradually increasing a control temperature of 22° C. (i.e., the daily maximum water temperature) by 1° C. (23° C., 24° C., 25° C., 26° C., 27° C., 28° C., 29° C., 30° C.) to explore a high-temperature stage high-temperature tolerance threshold in a high-temperature stage. A number of dead schizothoracine embryos and a number of hatched schizothoracine embryos are observed and recorded daily, where the schizothoracine embryos developing into malformed embryos are counted as the dead schizothoracine embryos. The high-temperature stage high-temperature tolerance threshold Tᵤₜₕᵣ in the high-temperature stage is ultimately determined based on a 60% hatching rate limit. For a control group of the fertilized eggs of Schizopygopsis microcephalus from Yangtze River source incubated with a low temperature of 7° C. to a high temperature of 22° C., a hatching rate of the schizothoracine embryos is 82.8% and a dead rate of the schizothoracine embryos is 17.2%. When using 7° C. as the low-temperature stimulation, the hatching rates with high-temperature stimulations of 23° C., 24° C., 25° C., 26° C., 27° C., and 28° C. are all above 60%, while the hatching rates with high-temperature stimulations exceeding 28° C. are all below 60%. Consequently, the high-temperature stage high-temperature tolerance threshold Tᵤₜₕᵣ for the high-temperature stage is determined to be 28° C. Similarly, during the hatching period, based on 22° C. as an upper limit temperature, a low-temperature gradient experiment is performed by gradually increasing a control temperature of 7° C. (i.e., the daily minimum water temperature) by 1° C. (8° C., 9° C., 10° C., 11° C., 12° C., 13° C., 14° C.) to explore a high-temperature stage high-temperature threshold in a low-temperature stage. The high-temperature stage high-temperature tolerance threshold Tₗₜₕᵣ in the low-temperature stage is determined based on the 60% hatching rate limit. When using 22° C. as the high-temperature stimulation, the hatching rates with low-temperature stimulations of 8° C., 9° C., 10° C., 11° C., and 12° C. are also above 60%, while the hatching rates with low-temperature stimulations exceeding 12° C. are all below 60%. Consequently, the high-temperature stage high-temperature tolerance threshold Tₗₜₕᵣ for the low-temperature stage is determined to be 12° C.

In the development of the incubation temperature regime for the fertilized eggs of Schizopygopsis microcephalus from the Yangtze River source utilizing a low temperature of 7° C. to a high temperature of 22° C., the key hatching temperature is determined as 19° C. the mass hatching of the schizothoracine embryos is induced following sequential stimulation with the low temperature Tₗ, maintained within a range greater than or equal to 7° C. and less than 12° C. (i.e., the low-temperature stage), and the high temperature Tₕ, maintained within a range greater than or equal to 19° C. and less than 28° C. (i.e., the high-temperature stage). The low-temperature stage high-temperature tolerance threshold Tₗₜₕᵣ in the low-temperature stage of the schizothoracine embryos is determined to be 12° C., and the high-temperature stage high-temperature tolerance threshold Tᵤₜₕᵣ in the high-temperature stage is determined to be 28° C. A high hatching rate of 82.8% and a low dead rate of 17.2% demonstrate the effectiveness of the experimental met and its high controllability.

### Embodiment 2

Construction of incubation water temperature for schizothoracine fish eggs at low-temperature 9° C. to high-temperature 24° C.

### 1. Determination of Daily Extreme Water Temperatures and a Daily Water Temperature Variation During Natural Incubation of Schizothoracine Fish Eggs

Specifically, an automatic underwater temperature recorder is installed at spawning site of Schizopygopsis microcephalus to record hourly water temperatures during an incubation period of the schizothoracine fish eggs. Based on the hourly water temperatures, diurnal periodicity is analyzed by using wavelet analysis to determine that a daily maximum water temperature Tₘₐₓ is 22° C. and a daily minimum water temperature Tₘᵢₙ is 7° C. Considering the impact of climate change on the natural incubation water temperatures of the fertilized eggs at the spawning site of Schizopygopsis microcephalus, it is anticipated that future daily maximum, minimum, and average temperatures will concurrently rise. An experimental ecological model is constructed to simulate future scenarios with a daily maximum water temperature Tₘₐₓ of 24° C. and a daily minimum water temperature of Tₘᵢₙ 9° C. for the incubation temperature system of the fertilized eggs of Schizopygopsis microcephalus in the Yangtze River source.

### 2. Implementation of an Incubation Water Temperature With the Daily Water Temperature Variation

Specifically, an incubation process of the schizothoracine fish eggs is conducted by using an indoor basin-type artificial incubation method, with an incubation density of 45,000 eggs per square meter and a depth of incubation water of 18 cm. Spring water is used as the incubation water, which ensures excellent quality of the incubation water, while taking advantage of fewer bacteria and viruses in groundwater at high-altitude regions. A temperature of the spring water is 7° C., thus, the incubation water temperature is achieved by mixing the spring water with boiled spring water. An incubation room temperature is maintained at 14° C., and dissolved oxygen and ammonia nitrogen levels are appropriate during the incubation process. A light condition of the incubation process is set at 14L:10D, with no direct sunlight, where L represents daytime, and D represents nighttime. The incubation water temperature is set to (13° C., 24°C). A water temperature variation process during an incubation experiment of 24° C. is shown in FIG. 2. The incubation experiment starts at 16:45 on June 13^{th} and ends at 15:30 on June 21^{st}. During the incubation process, the incubation water temperature is increased once daily to 24° C., and then the incubation water temperature is automatically decreased to the incubation room temperature, to simulate diurnal temperature variation and promote embryonic development with a higher water temperature. A total of eight cooling and heating cycles are conducted throughout the incubation experiment. Four-fifths of the incubation water are replaced daily at 15:00 p.m. with new spring water adjusted to 24° C., and dead schizothoracine embryos are promptly removed to maintain freshness of the incubation water.

### 3. Determination of a Key Hatching Water Temperature

Specifically, a time when a tail of each of schizothoracine embryos is fully developed is determined as an optimal timing for hatching. When the tail of each of schizothoracine embryos is fully developed, the tail of the schizothoracine embryo encircles and extends a head of the schizothoracine embryo, a length of the tail of the schizothoracine embryo is approximately half of an inner membrane circumference of the schizothoracine embryo, and the schizothoracine embryos exhibit a preset movement state including tumbling and rotation. A hatching temperature is initially set to the daily minimum water temperature 9° C., and the hatching water temperature is gradually increased at a rate of 1° C. per 0.5-hour interval. The key hatching water temperature Tₕₐₜ is determined based on whether the schizothoracine embryos hatch. No hatching is observed when the hatching water temperature is increased to 18° C.; however, a certain number of the schizothoracine embryos begins to hatch when the hatching water temperature is increased to 19° C., thus determining the key hatching water temperature as 19° C.

### 4. Induction of Mass Hatching of the Schizothoracine Embryos Through Low-High Temperature Stimulation

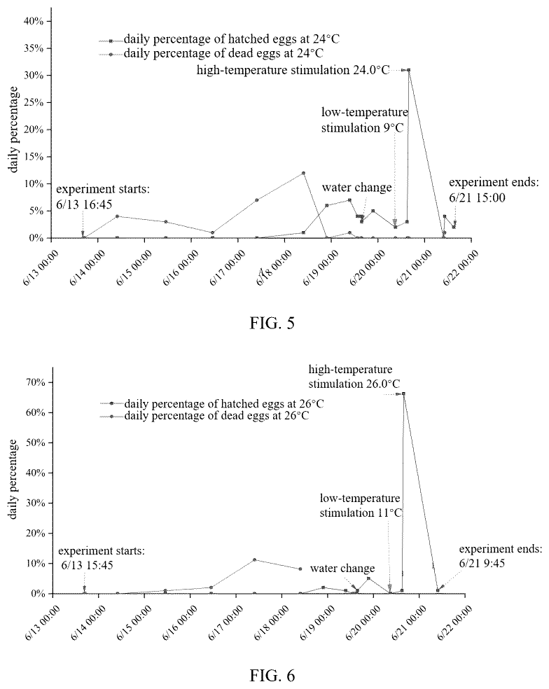

Specifically, an arrival of a peak (corresponding to the afternoon of June 19^{th} of FIG. 2) of a hatching period of the schizothoracine embryos is determined. Then, the fertilized eggs are first stimulated with the daily minimum water temperature Tₘᵢₙ (9° C.) from 9:00 a.m. to 10:00 a.m., followed by stimulation with the daily maximum water temperature Tₘₐₓ (24° C.) from 15:00 p.m. to 17:00 p.m., to thereby achieve the low-high temperature stimulation. As shown in FIG. 5, it illustrates daily percentage changes of hatched schizothoracine embryos and dead schizothoracine embryos (i.e., daily percentages of hatched eggs and dead eggs) for the incubation experiment of 24° C. After the low-high temperature stimulation, the mass hatching of the schizothoracine embryos occurs with an effective period of 3 hours. The daily percentage of the hatched schizothoracine embryos reaches a maximum on the afternoon of June 20^{th}, confirming the induction of the mass hatching. Thus, the low-high temperature stimulation actively promotes and facilitates the hatching of the schizothoracine embryos.

### 5. Determination of Dual-High Temperature Tolerance Thresholds

Specifically, during the hatching period, based on 9° C. as a lower limit temperature, a high-temperature gradient experiment is performed by gradually increasing a control temperature of 24° C. by 1° C. (25° C., 26° C., 27° C., 28° C., 29° C., 30° C.) to explore a high-temperature stage high-temperature tolerance threshold in a high-temperature stage. A number of dead schizothoracine embryos and a number of hatched schizothoracine embryos are observed and recorded daily, where the schizothoracine embryos developing into malformed embryos are counted as dead schizothoracine embryos. The high-temperature stage high-temperature tolerance threshold Tᵤₜₕᵣ in the high-temperature stage is ultimately evaluated based on a 60% hatching rate limit. For a control group of the fertilized eggs of Schizopygopsis microcephalus from Yangtze River source incubated with a low temperature of 9° C. to a high temperature of 24° C., a hatching rate of the schizothoracine embryos is 71% and a dead rate of the schizothoracine embryos is 29%. When using 9° C. as the low-temperature stimulation, the hatching rates with high-temperature stimulations of 25° C., 26° C., 27° C., and 28° C. are all above 60%, while the hatching rates with high-temperature stimulations exceeding 28° C. are all below 60%. Consequently, the high-temperature stage high-temperature tolerance threshold Tᵤₜₕᵣ for the high-temperature stage is determined to be 28° C. Similarly, during the hatching period, based on 24° C. as an upper limit temperature, a low-temperature gradient experiment is designed by gradually increasing a control temperature of 9° C. by 1° C. (10° C., 11° C., 12° C., 13° C., 14° C.) to explore a low-temperature stage high-temperature threshold in a low-temperature stage. The low-temperature stage high-temperature tolerance threshold Tₗₜₕᵣ in the low-temperature stage is determined based on the 60% hatching rate limit. When using 24° C. as the high-temperature stimulation, the hatching rates with low-temperature stimulations of 10° C., 11° C., and 12° C. are also above 60%, while the hatching rates with low-temperature stimulations exceeding 12° C. are all below 60%. Consequently, the low-temperature stage high-temperature tolerance threshold Tₗₜₕᵣ in the low-temperature stage is determined to be 12° C.

In the development of the incubation temperature regime for the fertilized eggs of Schizopygopsis microcephalus from the Yangtze River source utilizing a low temperature of 9° C. to a high temperature of 24° C., the key hatching temperature is determined as 19° C. the mass hatching of the schizothoracine embryos is induced following sequential stimulation with the low temperature Tₗ, maintained within a range greater than or equal to 9° C. and less than 12° C. (i.e., the low-temperature stage), and the high temperature Tₕ, maintained within a range greater than or equal to 19° C. and less than 24° C. (i.e., the high-temperature stage). The low-temperature stage high-temperature tolerance threshold Tₗₜₕᵣ in the low-temperature stage is determined to be 12° C., and the high-temperature stage high-temperature tolerance threshold Tᵤₜₕᵣ in the high-temperature stage is determined to be 28° C. A high hatching rate of 71% and a low dead rate of 29% demonstrate the effectiveness of the experimental method and its high controllability.

### Embodiment 3

Construction of incubation water temperature for schizothoracine fish eggs at low-temperature 11° C. to high-temperature 26° C.

### 1. Determination of Daily Extreme Water Temperatures and a Daily Water Temperature Variation During Natural Incubation of Schizothoracine Fish Eggs

Specifically, an automatic underwater temperature recorder is installed at spawning site of Schizopygopsis microcephalus to record hourly water temperatures during an incubation period of the fertilized eggs. Based on the hourly water temperatures, diurnal periodicity is analyzed by using wavelet analysis to determine that a daily maximum water temperature Tₘₐₓ is 22° C. and a daily minimum water temperature Tₘᵢₙ is 7° C. Considering the impact of climate change on the natural incubation water temperatures of the fertilized eggs at the spawning site of Schizopygopsis microcephalus, it is anticipated that future daily maximum, minimum, and average temperatures will concurrently rise. An experimental ecological model is constructed to simulate future scenarios with a daily maximum water temperature Tₘₐₓ of 26° C. and a daily minimum water temperature of Tₘᵢₙ 11° C. for the incubation temperature system of the fertilized eggs of Schizopygopsis microcephalus in the Yangtze River source.

### 2. Implementation of an Incubation Water Temperature With the Daily Water Temperature Variation

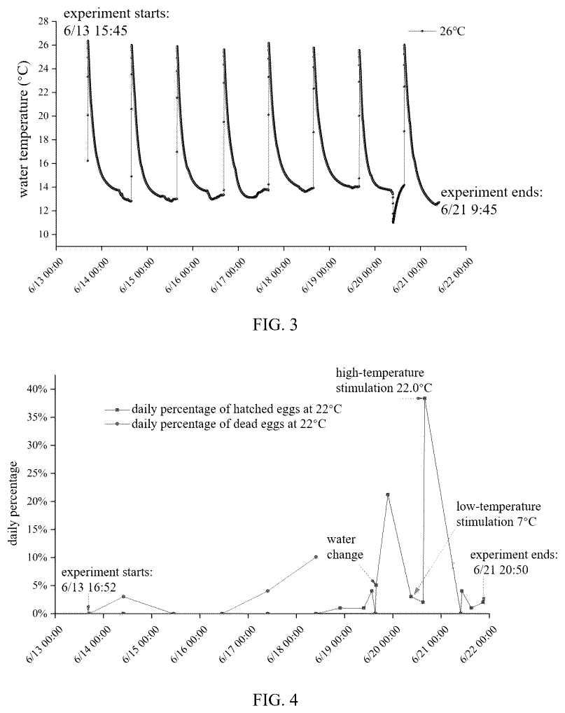

Specifically, an incubation process of the schizothoracine fish eggs is conducted by using an indoor basin-type artificial incubation method, with an incubation density of 50,000 eggs per square meter and a depth of incubation water of 20 cm. Spring water is used as the incubation water, which ensures excellent quality of the incubation water, while taking advantage of fewer bacteria and viruses in groundwater at high-altitude regions. A temperature of the spring water is 9° C., thus, the incubation water temperature is achieved by mixing the spring water with boiled spring water. An incubation room temperature is maintained at 15° C., and dissolved oxygen and ammonia nitrogen levels are appropriate during the incubation process. A light condition of the incubation process is set at 14L:10D, with no direct sunlight, where L represents daytime, and D represents nighttime. The incubation water temperature is set to (13° C., 26°C). A water temperature variation process during an incubation experiment of 26° C. is shown in FIG. 3. The incubation experiment starts at 15:45 on June 13^{th} and ends at 9:45 on June 21^{st}. During the incubation process, the incubation water temperature is increased once daily to 26° C., and then the incubation water temperature is automatically decreased to the incubation room temperature, to simulate diurnal temperature variation and promote embryonic development with a higher water temperature. A total of eight cooling and heating cycles are conducted throughout the incubation experiment. Four-fifths of the incubation water are replaced daily at 15:00 p.m. with new spring water adjusted to 26° C., and dead schizothoracine embryos are promptly removed to maintain freshness of the incubation water.

### 3. Determination of a Key Hatching Water Temperature

Specifically, a time when a tail of each of schizothoracine embryos is fully developed is determined as an optimal timing for hatching. When the tail of each of schizothoracine embryos is fully developed, the tail of the schizothoracine embryo encircles and extends a head of the schizothoracine embryo, a length of the tail of the schizothoracine embryo is approximately half of an inner membrane circumference of the schizothoracine embryo, and the schizothoracine embryos exhibit a preset movement state including tumbling and rotation. A hatching temperature is initially set to the daily minimum water temperature 11° C., and the hatching water temperature is gradually increased at a rate of 1° C. per 0.5-hour interval. The key hatching water temperature Tₕₐₜ is determined based on whether the schizothoracine embryos hatch. No hatching is observed when the hatching water temperature is increased to 18° C.; however, a certain number of the schizothoracine embryos begins to hatch when the hatching water temperature is increased to 19° C., thus determining the key hatching water temperature as 19° C.

### 4. Induction of Mass Hatching of the Schizothoracine Embryos Through Low-High Temperature Stimulation

Specifically, an arrival of a peak (corresponding to the afternoon of June 19^{th} of FIG. 3) of a hatching period of the schizothoracine embryos is determined. Then, the fertilized eggs are first stimulated with the daily minimum water temperature Tₘᵢₙ (11° C.) from 9:00 a.m. to 10:00 a.m., followed by stimulation with the daily maximum water temperature Tₘₐₓ (26° C.) from 15:00 p.m. to 17:00 p.m., to thereby achieve the low-high temperature stimulation. As shown in FIG. 6, it illustrates daily percentage changes in hatched schizothoracine embryos and dead schizothoracine embryos (i.e., daily percentage changes of hatched eggs and dead eggs) for the incubation experiment of 26° C. After the low-high temperature stimulation, the mass hatching of the schizothoracine embryos occurs with an effective period of 3 hours. The daily percentage of the hatched schizothoracine embryos reaches a maximum on the afternoon of June 20^{th}, confirming the induction of the mass hatching. Thus, the low-high temperature stimulation actively promotes and facilitates the hatching of the schizothoracine embryos.

### 5. Determination of Dual-High Temperature Tolerance Thresholds

Specifically, during the hatching period, based on 11° C. as a lower limit temperature, a high-temperature gradient experiment is performed by gradually increasing a control temperature of 26° C. by 1° C. (27° C., 28° C., 29° C., 30° C.) to explore a high-temperature stage high-temperature tolerance threshold in a high-temperature stage. A number of dead schizothoracine embryos and a number of hatched schizothoracine embryos are observed and recorded daily, where the schizothoracine embryos developing into malformed embryos are counted as dead schizothoracine embryos. The high-temperature stage high-temperature tolerance threshold Tᵤₜₕᵣ in the high-temperature stage is ultimately evaluated based on a 60% hatching rate limit. For a control group of the fertilized eggs of Schizopygopsis microcephalus from Yangtze River source incubated with a low temperature of 11° C. to a high temperature of 26° C., a hatching rate of the schizothoracine embryos is 77.6% and a dead rate of the schizothoracine embryos is 22.4%. When using 11° C. as the low-temperature stimulation, the hatching rates with high-temperature stimulations of 27° C., and 28° C. are all above 60%, while the hatching rates with high-temperature stimulations exceeding 28° C. are all below 60%. Consequently, the high-temperature stage high-temperature tolerance threshold Tᵤₜₕᵣ for the high-temperature stage is determined to be 28° C. Similarly, during the hatching period, based on 26° C. as an upper limit temperature, a low-temperature gradient experiment is designed by gradually increasing a control temperature of 11° C. by 1° C. (12° C., 13° C., 14° C.) to explore a low-temperature stage high-temperature threshold in a low-temperature stage. The low-temperature stage high-temperature tolerance threshold Tₗₜₕᵣ in the low-temperature stage is determined based on the 60% hatching rate limit. When using 26° C. as the high-temperature stimulation, the hatching rates with low-temperature stimulations of 10° C., 11° C., and 12° C. are also above 60%, while the hatching rates with low-temperature stimulations exceeding 12° C. are all below 60%. Consequently, the low-temperature stage high-temperature tolerance threshold Tₗₜₕᵣ in the low-temperature stage is determined to be 12° C.

In the development of the incubation temperature regime for the fertilized eggs of Schizopygopsis microcephalus from the Yangtze River source utilizing a low temperature of 11° C. to a high temperature of 26° C., the key hatching temperature is determined as 19° C. the mass hatching of the schizothoracine embryos is induced following sequential stimulation with the low temperature Tₗ, maintained within a range greater than or equal to 11° C. and less than 12° C. (i.e., the low-temperature stage), and the high temperature Tₕ, maintained within a range greater than or equal to 19° C. and less than 26° C. (i.e., the high-temperature stage). The low-temperature stage high-temperature tolerance threshold Tₗₜₕᵣ in the low-temperature stage is determined to be 12° C., and the high-temperature stage high-temperature tolerance threshold Tᵤₜₕᵣ in the high-temperature stage is determined to be 28° C. A high hatching rate of 77.6% and a low dead rate of 22.4% demonstrate the effectiveness of the experimental method and its high controllability.

The disclosure aims to explore the dual-high temperature thresholds and the mechanism of mass hatching induced by low-high temperature stimulation of fertilized eggs of representative schizothoracine fish species in the Tibetan Plateau under the backdrop of global warming. The disclosure also provides an experimental method to study the unique temperature adaptations of schizothoracine fish and to support the cultivation of the fertilized eggs under artificial conditions. The specific plan includes determining the daily extreme water temperatures and the daily water temperature variation during natural incubation of fertilized eggs, implementing an incubation water temperature with the daily water temperature variation, controlling the key hatching water temperature, revealing the mechanism of mass hatching induced by low-high temperature stimulation, and determining the dual-high temperature tolerance thresholds. The disclosure can serve as a reference for the construction of hatching water temperature research for the fertilized eggs of other schizothoracine fish species.

In terms of results, the disclosure determines that the key hatching temperature for the fertilized eggs of Schizopygopsis microcephalus is 19° C., and the mass hatching occurring after stimulation by both low temperature Tₗ and high temperature Tₕ. The high-temperature tolerance threshold in the low-temperature zone for the fertilized eggs is identified as 12° C., and the high-temperature tolerance threshold in the high-temperature zone is 28° C. The high hatching rate and low mortality rate of the fertilized eggs indicate that the experiment is effective and highly controllable.

The above is only the specific embodiments of the disclosure, but the scope of protection of the disclosure is not limited to these. Any changes or substitutions that can be easily conceived by those skilled in the art within the scope of the disclosed technology should be included in the scope of protection of the disclosure. Therefore, the scope of protection of the disclosure should be based on the scope of protection of the appended claims.

What is claimed is:

1. An experimental method for hatching stimulation and temperature tolerance threshold determination for schizothoracine fish eggs, comprising the following steps:
step 1, determining daily extreme water temperatures and a daily water temperature variation during natural incubation of the schizothoracine fish eggs, comprising:
installing an automatic underwater temperature recorder at a spawning site to record hourly water temperatures during an incubation period of the schizothoracine fish eggs, and analyzing, based on the hourly water temperatures, diurnal periodicity by using wavelet analysis to determine a daily maximum water temperature Tₘₐₓ and a daily minimum water temperature Tₘᵢₙ;
step 2, implementing an incubation water temperature with the daily water temperature variation, comprising:
conducting an incubation process of the schizothoracine fish eggs by using an indoor basin-type artificial incubation method, with an incubation density of 40,000 eggs per square meter to 50,000 eggs per square meter and a depth of incubation water of 15 centimeters (cm) to 20 cm; using spring water with a temperature of 5° C. to 9° C. as the incubation water, and mixing the spring water with boiled spring water to achieve the incubation water temperature; maintaining an incubation room temperature at 13° C. to 14° C., corresponding to an average temperature during the natural incubation of the schizothoracine fish eggs, to shorten an incubation time of the schizothoracine fish eggs, and setting a lighting condition of the incubation process to 14L:10D, with no direct sunlight, where L represents daytime, and D represents nighttime; setting the incubation water temperature to (13° C., Tₘₐₓ); during the incubation process, increasing the incubation water temperature once daily to Tₘₐₓ, and then automatically decreasing the incubation water temperature to the incubation room temperature, to simulate diurnal temperature variation and promote embryonic development; and replacing, daily at 15:00 p.m., four-fifths of the incubation water with new spring water adjusted to a temperature of Tₘₐₓ, and promptly removing dead schizothoracine embryos to maintain freshness of the incubation water;
step 3, determining a key hatching water temperature, comprising:
determining a time when a tail of each of schizothoracine embryos is fully developed as an optimal timing for hatching, wherein when the tail of each of schizothoracine embryos is fully developed, the tail of the schizothoracine embryo encircles and extends to a head of the schizothoracine embryo, a length of the tail of the schizothoracine embryo is half of an inner membrane circumference of the schizothoracine embryo, and the schizothoracine embryos exhibit a preset movement state comprising tumbling and rotation; setting a hatching water temperature initially to the daily minimum water temperature Tₘᵢₙ, and increasing the hatching water temperature gradually at a rate of 1° C. per 0.5-hour interval; and determining, based on whether the schizothoracine embryos hatch, the key hatching water temperature Tₕₐₜ;
step 4, inducing mass hatching of the schizothoracine embryos through low-high temperature stimulation, comprising:
determining an arrival of a peak of a hatching period of the schizothoracine embryos, then stimulating the schizothoracine embryos with the incubation water of the daily minimum water temperature Tₘᵢₙ from 9:00 a.m. to 10:00 a.m., and subsequently stimulating the schizothoracine embryos with the incubation water of the daily maximum water temperature Tₘₐₓ from 15:00 p.m. to 17:00 p.m., to thereby achieve the low-high temperature stimulation; and conducting, after the low-high temperature stimulation, the mass hatching of the schizothoracine embryos within an effective period of 3 hours, wherein the low-high temperature stimulation promotes the hatching of the schizothoracine embryos; and
step 5, determining temperature tolerance thresholds, comprising:
during the hatching period, performing, based on the daily minimum water temperature Tₘᵢₙ as a lower limit temperature, a high-temperature gradient experiment by gradually increasing the daily maximum water temperature Tₘₐₓ by 1° C. to explore a high-temperature stage high-temperature tolerance threshold in a high-temperature stage, daily observing and recording a number of dead schizothoracine embryos and a number of hatched schizothoracine embryos, and determining, based on a 60% hatching rate limit, the high-temperature stage high-temperature tolerance threshold T^{uthr} in the high-temperature stage; and
during the hatching period, performing, based on the daily maximum water temperature Tₘₐₓ as an upper limit temperature, a low-temperature gradient experiment by gradually increasing the daily minimum water temperature Tₘᵢₙ by 1° C. to explore a low-temperature stage high-temperature tolerance threshold in a low-temperature stage, and determining, based on the 60% hatching rate limit, the low-temperature stage high-temperature tolerance threshold Tₗₜₕᵣ in the low-temperature stage.

2. The experimental method for hatching stimulation and temperature tolerance threshold determination for schizothoracine fish eggs as claimed in claim 1, wherein the daily minimum water temperature Tₘᵢₙ is less than or equal to 12° C., and the daily maximum water temperature Tₘₐₓ is greater than the key hatching water temperature Tₕₐₜ and is further greater than or equal to 22° C.

3. The experimental method for hatching stimulation and temperature tolerance threshold determination for schizothoracine fish eggs as claimed in claim 2, wherein the daily minimum water temperature Tₘᵢₙ is 7° C., and the daily maximum water temperature Tₘₐₓ is 22° C.

4. The experimental method for hatching stimulation and temperature tolerance threshold determination for schizothoracine fish eggs as claimed in claim 2, wherein the daily minimum water temperature Tₘᵢₙ is set to 9° C., and the daily maximum water temperature Tₘₐₓ is set to 24° C.

5. The experimental method for hatching stimulation and temperature tolerance threshold determination for schizothoracine fish eggs as claimed in claim 2, wherein the daily minimum water temperature Tₘᵢₙ is set to 11° C, and the daily maximum water temperature Tₘₐₓ is set to 26° C.

6. The experimental method for hatching stimulation and temperature tolerance threshold determination for schizothoracine fish eggs as claimed in claim 3, wherein the key hatching water temperature Tₕₐₜ is 19° C.

7. The experimental method for hatching stimulation and temperature tolerance threshold determination for schizothoracine fish eggs as claimed in claim 3, wherein the high-temperature gradient experiment is performed in a temperature range of 23° C. to 30° C.

8. The experimental method for hatching stimulation and temperature tolerance threshold determination for schizothoracine fish eggs as claimed in claim 3, wherein the low-temperature gradient experiment is performed in a temperature range of 8° C. to 14° C.

9. The experimental method for hatching stimulation and temperature tolerance threshold determination for schizothoracine fish eggs as claimed in claim 3, wherein a hatching rate of the schizothoracine embryos is 82.8%, and a death rate of the schizothoracine embryos is 17.2%.

10. The experimental method for hatching stimulation and temperature tolerance threshold determination for schizothoracine fish eggs as claimed in claim 4, wherein a hatching rate of the schizothoracine embryos is 71%, and a death rate of the schizothoracine embryos is 29%.

11. The experimental method for hatching stimulation and temperature tolerance threshold determination for schizothoracine fish eggs as claimed in claim 5, wherein a hatching rate of the schizothoracine embryos is 77.6%, and a death rate of the schizothoracine embryos is 22.4%.

12. The experimental method for hatching stimulation and temperature tolerance threshold determination for schizothoracine fish eggs as claimed in claim 7, wherein the high-temperature stage high-temperature tolerance threshold Tᵤₜₕᵣ in the high-temperature stage is 28° C.

13. The experimental method for hatching stimulation and temperature tolerance threshold determination for schizothoracine fish eggs as claimed in claim 8, wherein the low-temperature stage low-temperature tolerance threshold Tₗₜₕᵣ in the low-temperature stage is 12° C.

14. An experimental method for hatching stimulation and temperature tolerance threshold determination for schizothoracine fish eggs, comprising the following steps:
step 1, determining daily extreme water temperatures and a daily water temperature variation during natural incubation of the schizothoracine fish eggs;
step 2, implementing an incubation water temperature with the daily water temperature variation;
step 3, determining a key hatching water temperature;
step 4, inducing mass hatching of the schizothoracine embryos through low-high temperature stimulation; and
step 5, determining temperature tolerance thresholds.

15. The experimental method for hatching stimulation and temperature tolerance threshold determination for schizothoracine fish eggs as claimed in claim 14, wherein the step 1 comprises:
installing an automatic underwater temperature recorder at a spawning site to record hourly water temperatures during an incubation period of the schizothoracine fish eggs, and analyzing, based on the hourly water temperatures, diurnal periodicity by using wavelet analysis to determine a daily maximum water temperature Tₘₐₓ and a daily minimum water temperature Tₘᵢₙ.

16. The experimental method for hatching stimulation and temperature tolerance threshold determination for schizothoracine fish eggs as claimed in claim 14, wherein the step 2 comprises:
conducting an incubation process of the schizothoracine fish eggs by using an indoor basin-type artificial incubation method, with an incubation density of 40,000 eggs per square meter to 50,000 eggs per square meter and a depth of incubation water of 15 centimeters (cm) to 20 cm; using spring water with a temperature of 5° C. to 9° C. as the incubation water, and mixing the spring water with boiled spring water to achieve the incubation water temperature; maintaining an incubation room temperature at 13° C. to 14° C., corresponding to an average temperature during the natural incubation of the schizothoracine fish eggs, to shorten an incubation time of the schizothoracine fish eggs, and setting a lighting condition of the incubation process to 14L:10D, with no direct sunlight, where L represents daytime, and D represents nighttime; setting the incubation water temperature to (13° C., Tₘₐₓ); during the incubation process, increasing the incubation water temperature once daily to Tₘₐₓ, and then automatically decreasing the incubation water temperature to the incubation room temperature, to simulate diurnal temperature variation and promote embryonic development; and replacing, daily at 15:00 p.m., four-fifths of the incubation water with new spring water adjusted to a temperature of Tₘₐₓ, and promptly removing dead schizothoracine embryos to maintain freshness of the incubation water.

17. The experimental method for hatching stimulation and temperature tolerance threshold determination for schizothoracine fish eggs as claimed in claim 14, wherein the step 3 comprises:
determining a time when a tail of each of schizothoracine embryos is fully developed as an optimal timing for hatching, wherein when the tail of each of schizothoracine embryos is fully developed, the tail of the schizothoracine embryo encircles and extends to a head of the schizothoracine embryo, a length of the tail of the schizothoracine embryo is half of an inner membrane circumference of the schizothoracine embryo, and the schizothoracine embryos exhibit a preset movement state comprising tumbling and rotation; setting a hatching water temperature initially to the daily minimum water temperature Tₘᵢₙ, and increasing the hatching water temperature gradually at a rate of 1° C. per 0.5-hour interval; and determining, based on whether the schizothoracine embryos hatch, the key hatching water temperature Tₕₐₜ.

18. The experimental method for hatching stimulation and temperature tolerance threshold determination for schizothoracine fish eggs as claimed in claim 14, wherein the step 4 comprises:
determining an arrival of a peak of a hatching period of the schizothoracine embryos, then stimulating the schizothoracine embryos with the incubation water of the daily minimum water temperature Tₘᵢₙ from 9:00 a.m. to 10:00 a.m., and subsequently stimulating the schizothoracine embryos with the incubation water of the daily maximum water temperature Tₘₐₓ from 15:00 p.m. to 17:00 p.m., to thereby achieve the low-high temperature stimulation; and conducting, after the low-high temperature stimulation, the mass hatching of the schizothoracine embryos within an effective period of 3 hours, wherein the low-high temperature stimulation promotes the hatching of the schizothoracine embryos.

19. The experimental method for hatching stimulation and temperature tolerance threshold determination for schizothoracine fish eggs as claimed in claim 14, wherein the step 5 comprises:
during the hatching period, performing, based on the daily minimum water temperature Tₘᵢₙ as a lower limit temperature, a high-temperature gradient experiment by gradually increasing the daily maximum water temperature Tₘₐₓ by 1° C. to explore a high-temperature stage high-temperature tolerance threshold in a high-temperature stage, daily observing and recording a number of dead schizothoracine embryos and a number of hatched schizothoracine embryos, and determining, based on a 60% hatching rate limit, the high-temperature stage high-temperature tolerance threshold Tᵤₜₕᵣ in the high-temperature stage; and
during the hatching period, performing, based on the daily maximum water temperature Tₘₐₓ as an upper limit temperature, a low-temperature gradient experiment by gradually increasing the daily minimum water temperature Tₘᵢₙ by 1° C. to explore a low-temperature stage high-temperature tolerance threshold in a low-temperature stage, and determining, based on the 60% hatching rate limit, the low-temperature stage high-temperature tolerance threshold Tₗₜₕᵣ in the low-temperature stage.

20. The experimental method for hatching stimulation and temperature tolerance threshold determination for schizothoracine fish eggs as claimed in claim 15, wherein the daily minimum water temperature Tₘᵢₙ is 7° C., and the daily maximum water temperature Tₘₐₓ is 22° C.
